(19) United States
(12) Patent Application Publication
(10) Pub. No.: US 2008/0116676 A1
(43) Pub. Date: May 22, 2008

(54) Steering column of vehicle

(76) Inventor: Sung Hun Cho, Anyang-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/642,450

(22) Filed: Dec. 20, 2006

(30) Foreign Application Priority Data
Nov. 21, 2006 (KR) 10-2006-0115220

(51) Int. Cl. B62D 1/18; B60K 20/06

(52) U.S. Cl. 280/775; 74/473.31

(57) ABSTRACT

A steering column of a vehicle can protect a driver's knee by disposing an operation lever inside a column cover in a locked state of the operation lever. The steering column may include a main housing provided with a column tube therein; an upper housing rotatably connected to the column tube, and with gear teeth at a lower portion of the upper housing; a bracket having a first end rotatably connected to the main housing, and gear teeth at a second end of the bracket and engaged with the gear teeth of the upper housing; and an operation lever having one end rotatably connected to the column cover, the operation lever pushing the bracket and engaging the upper housing with the bracket.

### CROSS-REFERENCE TO RELATED APPLICATION

This application claims priority to and the benefit of Korean Patent Application No. 10-2006-0115220 filed in the Korean Intellectual Property Office on Nov. 21, 2006, the entire contents of which are incorporated herein by reference.

### BACKGROUND OF THE INVENTION

(a) Field of the Invention

The present invention relates to a steering column of a vehicle. More particularly, the present invention relates to a steering column of a vehicle that can protect a driver's knee by disposing an operation lever inside a column cover in a locked state of the operation lever.

(b) Description of the Related Art

Generally, a steering system includes a steering wheel, a steering shaft connected to the steering wheel, and a steering column that includes a column tube wrapping the steering shaft, a main housing mounted at an exterior surface of the column tube, an upper housing rotatably connected to the column tube, and an operation lever for tilting and telescoping of the steering column.

A driver locks the operation lever and fixes the upper housing after controlling a position of the steering column by moving the upper housing in an unlocked state of the operation lever.

The steering column is installed in a protective column cover. One end of the operation lever protrudes outside of the column cover so the driver can control the operation lever easily. The operation lever is aesthetically unpleasing, and in the case of a collision, a knee of the driver may bump the operation lever and be injured.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a steering column of a vehicle that protects a driver's knee by disposing an operation lever inside a column cover when the operation lever is in a locked state.

A steering column installed in a column cover may include a main housing provided with a column tube therein; an upper housing rotatably connected to the column tube, with gear teeth at a lower portion of the upper housing; a bracket having a first end rotatably connected to the main housing, and a second end with gear teeth engaged with the gear teeth of the upper housing; and an operation lever having a first end rotatably connected to the column cover, the operation lever pushing the bracket and engaging the upper housing with the bracket.

A second end of the operation lever may be press fitted to the column cover.

A groove may be provided at the second end of the operation lever.

A shock-absorbing member may be attached to the operation lever.

An elastic member, such as a coil spring, may be interposed between the bracket and the main housing.

### BRIEF DESCRIPTION OF THE DRAWINGS

FIG. 1 is a side view of a steering column of a vehicle according to an exemplary embodiment of the present invention.

FIG. 2 is a rear view of a steering column of a vehicle according to an exemplary embodiment of the present invention.

FIG. 3 shows a locked state of an operation lever according to an exemplary embodiment of the present invention.

FIG. 4 shows an unlocked state of an operation lever according to an exemplary embodiment of the present invention.

### DETAILED DESCRIPTION OF THE PREFERRED EMBODIMENTS

An exemplary embodiment of the present invention will hereinafter be described in detail with reference to the accompanying drawings.

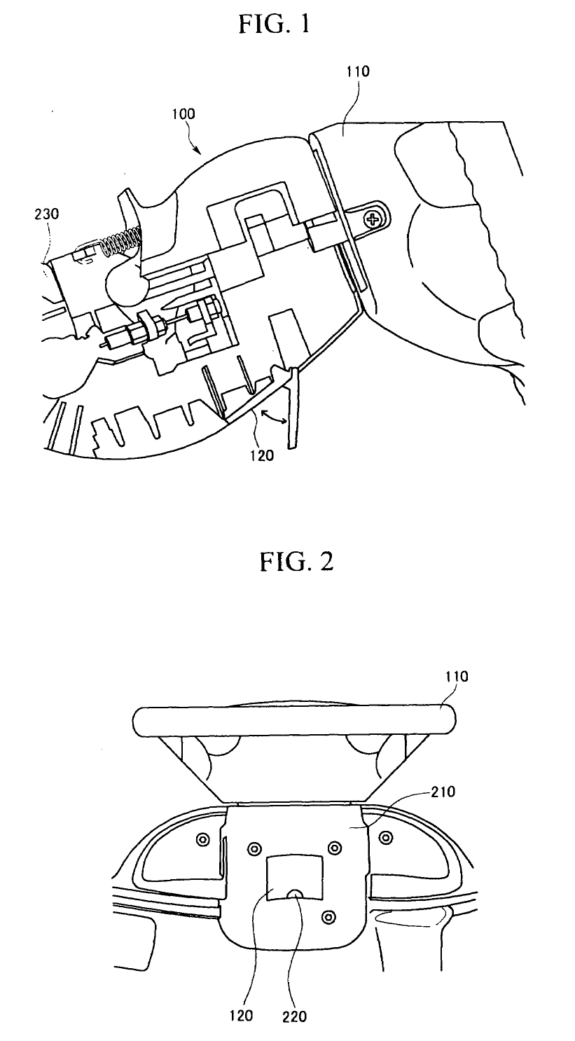

As shown in FIG. 1 and FIG. 2, a steering column 100 of a vehicle according to an exemplary embodiment of the present invention is installed in a column cover 210. The column cover 210 may be made of plastic. A steering shaft (not shown) is installed in the steering column 100, and the steering shaft is wrapped by a column tube 230. In addition, one end of the steering shaft is coupled with a steering wheel 110.

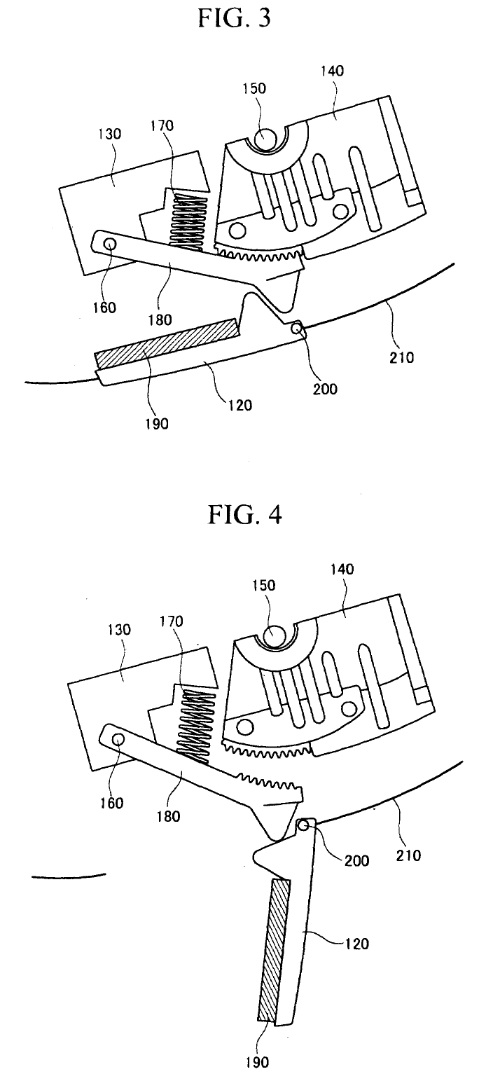

As shown in FIG. 3 and FIG. 4, the steering column 100 may include a main housing 130 mounted at an exterior surface of the column tube 230 to protect the column tube 230. An upper housing 140 is connected to the column tube 230 and rotates around a first hinge axis 150 to adjust a position of the steering wheel 110. Gear teeth for fixing a position of the upper housing 140 are provided at a lower portion of the upper housing 140.

A bracket 180 has a first end connected to the main housing 130 that rotates around a second hinge axis 160, and gear teeth engaged with the gear teeth of the upper housing 140 are provided at an upper surface of a second end of the bracket 180. Therefore, the bracket 180 fixes the upper housing 140 at a specific position. In addition, a lower surface of the second end of the bracket 180 protrudes such that the operation lever 120 rotates and pushes the bracket 180 with ease.

In addition, an elastic member 170, such as a coil spring, is interposed between the main housing 130 and the bracket 180. When the operation lever 120 does not push the bracket 180, the elastic member 170 applies an elastic force to the bracket 180 and disengages the bracket 180 from the upper housing 140.

One end of the operation lever 120 is connected to the column cover 210 and rotates around a third hinge axis 200. The other end of the operation lever 120 is press fitted to the column cover 210. In addition, as shown in FIG. 2, a groove 220 is provided at the other end of the operation lever 120. A driver inserts his finger in the groove 220 and rotates the operation lever 120 around the third hinge axis 200.

A shock-absorbing member 190 is attached to the operation lever 120. The shock-absorbing member 190 reduces impact when a knee of the driver bumps the operation lever 120. The shock-absorbing member 190 may be foam plastic. In addition, an upper surface of the operation lever 120 protrudes such that the operation lever contacts with the bracket 180 and pushes the bracket 180 with ease.

As shown in FIG. 3, in a locked state of the operation lever 120, the operation lever 120 pushes the bracket 180 and engages the bracket 180 with the upper housing 140. Thus, the upper housing 140 is fixed. In addition, the other end of the operation lever 120 is press fitted to the column cover 210. Therefore, the operation lever 120 does not protrude outside from the column cover 210.

As shown in FIG. 4, when the driver inserts his finger in the groove 220 and rotates the operation lever 120 with reference to the third hinge axis 200, the elastic member 170 applies the elastic force to the bracket 180 and disengages the bracket 180 from the upper housing 140. In this state, the driver rotates the upper housing 140 with reference to the first hinge axis 150 and controls the position of the upper housing 140. After that, the driver pushes the operation lever 120 and engages the bracket 180 with the upper housing 140. Therefore, the upper housing 140 is fixed.

According to the present invention, when an operation lever is in a locked state, the operation lever may not protrude outside from a column cover and bump probability of a driver may be lowered. Therefore, a knee of the driver may be protected.

In addition, since a foam plastic is attached on the operation lever, impact may be reduced in the case that the knee of driver bumps the operation lever.

In addition, since a column cover is closed up by the operation lever, a steering column may be protected from dust.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A steering column of a vehicle installed in a column cover, comprising:
a main housing provided with a column tube therein;
an upper housing rotatably connected to the column tube, comprising gear teeth at a lower portion of the upper housing;
a bracket comprising a first end rotatably connected to the main housing, and a second end comprising gear teeth engaged with the gear teeth of the upper housing in a locked state; and
an operation lever comprising a first end rotatably connected to the column cover, the operation lever pushing the bracket and engaging the upper housing with the bracket in the locked state.

2. The steering column of claim 1, wherein a second end of the operation lever is press fitted to the column cover in the locked state.

3. The steering column of claim 2, wherein the second end of the operation lever comprises a groove.

4. The steering column of claim 1, further comprising a shock-absorbing member attached to the operation lever.

5. The steering column of claim 1, further comprising an elastic member interposed between the bracket and the main housing.

6. The steering column of claim 5, wherein the elastic member comprises a coil spring.
